(19) United States
(12) Patent Application Publication
(10) Pub. No.: US 2010/0142999 A1
(43) Pub. Date: Jun. 10, 2010

(54) TONER, TWO-COMPONENT DEVELOPER, DEVELOPING DEVICE, FIXING DEVICE, AND IMAGE FORMING APPARATUS

(76) Inventor: Masahiko Kubo, Osaka-shi (JP)

Correspondence Address: NIXON & VANDERHYE, PC, 901 NORTH GLEBE ROAD, 11TH FLOOR, ARLINGTON, VA, 22203, US

(21) Appl. No.: 12/629,272

(22) Filed: Dec. 2, 2009

(30) Foreign Application Priority Data
Dec. 8, 2008 (JP) 2008-311942

(51) Int. Cl. G03G 15/08; G03G 9/08; G03G 9/087; G03G 9/09; G03G 9/093; G03G 15/20

(52) U.S. Cl. 399/252; 430/110.2; 399/320

(57) ABSTRACT

The present invention realizes: a toner that ensures fixing property only by a laser fixing system where a toner is fixed by irradiation of laser light whose wavelength is adjusted to be in an absorption wavelength range of each color of the toner, and realizes an image without poor color reproducibility caused by an infrared absorbent; a two-component developer containing the toner; a developing device; a fixing device; and an image forming apparatus. A capsule toner, which is the toner of the present invention, is arranged such that the capsule toner has a two-layer structure where a coating layer is formed around a surface of a core particle serving as a toner matrix particle, and nb/na is in a range of 0.92 to 0.96 where nb/na is a ratio of a refractive index of a resin making up the coating layer (nb) to a refractive index of a resin making up the core particle (na).

This Nonprovisional application claims priority under 35 U.S.C. §119(a) on Patent Application No. 2008-311942 filed in Japan on Dec. 8, 2008, the entire contents of which are hereby incorporated by reference.

### TECHNICAL FIELD

The present invention relates to a toner, a two-component developer, a developing device, a fixing device, and an image forming apparatus. Specifically, the present invention relates to a toner used in a fixing device where an unfixed toner image formed of the toner on a transfer material is irradiated with laser light having a wavelength in an absorption wavelength range of a color of the toner, so that the toner is fused by light energy to be fixed on the transfer material, a two-component developer containing the toner, a developing device, a fixing device, and an image forming apparatus.

### BACKGROUND ART

In an electrophotographic printing method, an electrostatic latent image is formed on a photoreceptor drum by photoconduction phenomenon, the electrostatic latent image is developed with a toner to form a toner image (visible image), and the toner image is then transferred and fixed on a recording paper. The toner image can be fixed using various kinds of fixing devices harnessing heat, pressure, and light. For example, a fixing device with heat rollers is most commonly used.

However, the fixing device with heat rollers has a high thermal efficiency but the following disadvantages: it takes time as much as about several tens of seconds for initial heating (start-up) of the device; a recording paper is easily contaminated with residual toner on the heat rollers by offset. Additionally, since the recording paper is nipped between a pair of heat rollers, wrinkles and breaks easily occur on a continuous paper when the paper travels in a snaking manner.

A fixing device harnessing pressure captures attention for its advantages including elimination of the need for warm-up and a heat source. However, this kind of fixing device has the difficulty of firmly fixing a toner image onto a recording paper. Additionally, the fixing device applies pressure to a recording paper nipped between a pair of rollers, which causes wrinkles and breaks to easily occur when the recording paper travels in a snaking manner. Further, in using a recent high-usage stick-on label, an adhesive paste may be squeezed out of between paper sheets of the label.

On the contrary, a fixing device harnessing energy of flashing light from a xenon lamp or the like allows a toner to absorb light energy in a selective manner, which enables high-speed fixing of a toner image. This kind of fixing device enables fixing in noncontact manner, which brings about the advantages that there is no concern about wrinkles and breaks of the recording paper caused by the aforementioned toner offset and snaky traveling of the recording paper, and that a toner image is easily fixed even onto the stick-on label described above without the problem that the adhesive paste is squeezed out.

However, the flash fixing has the following problem: Color toners hardly absorb intense light emitted from a xenon lamp although the flash fixing realizes sufficient fixing property with the use of a black toner which absorbs light of all wavelengths and thus absorbs intense light emitted from the xenon lamp and having a wavelength in a range of about 800 nm or more (800 nm to 1000 nm). To solve the problem, Patent Literature 1 makes an attempt to obtain fixing property by using a color toner that contains infrared absorbent that absorbs light in a near-infrared spectrum from a xenon lamp. However, among infrared absorbents that significantly absorb light in a near-infrared region, there is no ideal absorbent that absorbs less light in a visible region of not greater than 780 nm. Because of this, when such an infrared absorbent is added to a toner in an amount required to obtain sufficient fixing property, the toner absorbs light in a visible region, which causes poor color reproducibility.

In view of this, Patent Literature 2 proposes an image forming apparatus in which flash fixing and laser fixing are used in combination to reduce the amount of infrared absorbent to be added to a toner, and a light beam emitted from a laser light emitting device of a laser fixing section is adjusted to have a wavelength that is equal to a maximum absorption wavelength of each color toner so that a laser light beam exclusive to each color toner is emitted, whereby efficiency of heat supply is enhanced.

### Citation List

Patent Literature 1

Japanese Patent Application Publication, Tokukaihei, No. 11-38667 (Publication Date: Feb. 12, 1999)

Patent Literature 2

Japanese Patent Application Publication, Tokukai, No. 2008-107576 (Publication Date: May 8, 2008)

### SUMMARY OF INVENTION

### Technical Problem

The fixing method described in Patent Literature 2 enhances efficiency of heat supply by adjusting a light beam emitted from a laser light emitting device of a laser fixing section to have a wavelength that is equal to a maximum absorption wavelength of each color toner. However, such a fixing method cannot effectively reduce the amount of infrared absorbent to be added because light absorption efficiency of the toner itself is not optimized. This still remains unsolved the problem that the toner has poor color reproducibility. Further, the fixing method described in Patent Literature 2 requires two units, flash fixing system and laser fixing system as fixing systems, which causes a complex structure of the apparatus and increases a manufacturing cost.

The present invention has been attained in view of the foregoing problems, and an object thereof is to provide a toner that ensures fixing property only by a laser fixing system where a toner is fixed by irradiation of laser light whose wavelength is adjusted to be in an absorption wavelength range of each color of the toner, and realizes an image without poor color reproducibility caused by addition of an infrared absorbent, a two-component developer, a developing device, and an image forming apparatus.

### Solution to Problem

In order to solve the above problems, a toner according to the present invention is a toner used in a fixing device where an unfixed toner image formed of the toner on a transfer material is irradiated with laser light having a wavelength in an absorption wavelength range of a color of the toner, so that the toner is fused by light energy to be fixed on the transfer material, wherein: the toner has a two-layer structure where a coating layer is formed around a surface of a core particle serving as a toner matrix particle; and nb/na is in a range of 0.92 to 0.96 where nb/na is a ratio of a refractive index of a resin making up the coating layer (nb) to a refractive index of a resin making up the core particle (na).

In case of a normal toner, when laser light is directed into the toner, a light beam striking a pigment dispersed inside the toner is absorbed, but a light beam not striking the pigment is reflected and transmitted. The reflected and transmitted light beam strikes another pigment and is then absorbed. A light beam not striking to the other pigment is reflected and transmitted again. In the end, a light beam that is not absorbed by any of the pigments is released out of the toner. Thus, in a toner having insufficient light absorption efficiency, small amount of light is absorbed by a pigment. Such a toner cannot be heated, fused, and fixed on a transfer material only by irradiation of laser light.

On the contrary, a toner of the present invention is arranged such that the toner has a core-shell (core and shell) structure, and nb/na is in a range of 0.92 to 0.96 where nb/na is a ratio of a refractive index of a resin making up the coating layer (nb) to a refractive index of a resin making up the core particle (na), for enhancement of light absorption efficiency of the toner. According to the above arrangement, after laser light is directed into the core particle from the shell layer, part of light to be released from the core particle to the outside of the toner through the shell layer is confined within the core particle, which increases light absorption efficiency of the toner. This makes it possible to sufficiently heat and fuse the toner only by irradiation of laser light and thus ensure sufficient toner fixing to a transfer material. When the above-described ratio nb/na falls in the range of 0.92 to 0.96, light released from the core particle to the outside of the toner through the shell layer and light confined within the core particle are well-balanced. This makes it possible to sufficiently heat and fuse not only the upper layer of the toner but also the lower layer of the toner and thus sufficiently ensure sufficient fixing to a transfer material. This eliminates the need for addition of an infrared absorbent to the toner for fixing property of the toner and realizes an image without poor color reproducibility caused by the infrared absorbent.

A two-component developer of the present invention is characterized by containing the toner of the invention and a carrier.

The toner of the present invention has a high efficiency of light absorption and excellent property of fixing to a transfer material. Therefore, it is possible to provide a two-component developer which ensures sufficient fixing property over a long period of time and realizes an image without poor color reproducibility caused by addition of an infrared absorbent.

A developing device of the present invention is characterized by performing development using a developer containing the toner of the present invention.

According to the above arrangement, the developing device performs development using a developer containing the toner of the present invention. Therefore, it is possible to provide a developing device which ensures sufficient fixing property over a long period of time and realizes an image without poor color reproducibility caused by addition of an infrared absorbent.

A fixing device of the present invention is a fixing device where an unfixed toner image formed of a toner on a transfer material is irradiated with light from a light source, so that the toner is fused by light energy to be fixed on the transfer material, wherein: the light source comprises only laser light sources provided for respective colors of toners to be used; each of the laser light sources emits laser light having a wavelength in an absorption wavelength range of any particular color of the colors; and the toner has a two-layer structure where a coating layer is formed around a surface of a core particle serving as a toner matrix particle, and nb/na is in a range of 0.92 to 0.96 where nb/na is a ratio of a refractive index of a resin making up the coating layer (nb) to a refractive index of a resin making up the core particle (na).

The toner of the present invention has a two-layer structure where a shell layer is formed around the surface of a core particle, and improves a light absorption efficiency because a refractive index of the core particle is greater than that of the shell layer. The fixing device of the present invention includes laser light sources for respective color toners, whose wavelengths are respectively adjusted to be maximum absorption wavelengths of the color toners, to fix the toner of the present invention on a transfer material, which improves heat supply efficiencies of the respective color toners. This makes it possible to sufficiently heat and fuse the toner only by irradiation of laser light and thus ensure a sufficient toner fixing to a transfer material. This, in turn, eliminates the need for the addition of an infrared absorbent to the toner for obtaining of toner fixing property and realizes an image without poor color reproducibility caused by the infrared absorbent.

An image forming apparatus of the present invention is characterized by including (i) a developing device that performs development using a developer containing the toner of the present invention and (ii) a fixing device of the present invention. According to the above arrangement, the image forming apparatus includes the developing device and the fixing device. Therefore, it is possible to provide an image forming apparatus which ensures sufficient fixing property over a long period of time and realizes an image without poor color reproducibility caused by addition of an infrared absorbent.

### ADVANTAGEOUS EFFECTS OF INVENTION

As described above, a toner of the present invention is a toner used in a fixing device where an unfixed toner image formed of the toner on a transfer material is irradiated with laser light having a wavelength in an absorption wavelength range of a color of the toner, so that the toner is fused by light energy to be fixed on the transfer material, wherein: the toner has a two-layer structure where a coating layer is formed around a surface of a core particle serving as a toner matrix particle; and nb/na is in a range of 0.92 to 0.96 where nb/na is a ratio of a refractive index of a resin making up the coating layer (nb) to a refractive index of a resin making up the core particle (na). This yields the effect of eliminating the need for addition of an infrared absorbent to the toner for fixing property of the toner and realizing an image without poor color reproducibility caused by the infrared absorbent.

Further, a two-component developer, developing device, and image forming apparatus of the present invention uses the toner according to the present invention. This yields the effect of providing a two-component developer, a developing device, and an image forming apparatus that eliminates the need for addition of an infrared absorbent to the toner for fixing property of the toner and realizes an image without poor color reproducibility caused by the infrared absorbent.

### BRIEF DESCRIPTION OF DRAWINGS

FIG. 1 is a schematic diagram showing a capsule toner of the present invention.

FIG. 2 is a cross-sectional view showing the configuration of an image forming apparatus according to an embodiment of the present invention.

FIG. 3 is a cross-sectional view showing the configuration of a developing device according to an embodiment of the present invention.

FIG. 4 is a schematic diagram showing the configuration of a fixing device according to an embodiment of the present invention.

### DESCRIPTION OF EMBODIMENTS

The following will describe embodiments of the present invention. However, the present invention is not limited thereto.

Note that the wording “in a range of A to B” herein used is interpreted as “not less than A but not more than B”.

[1. Toner]

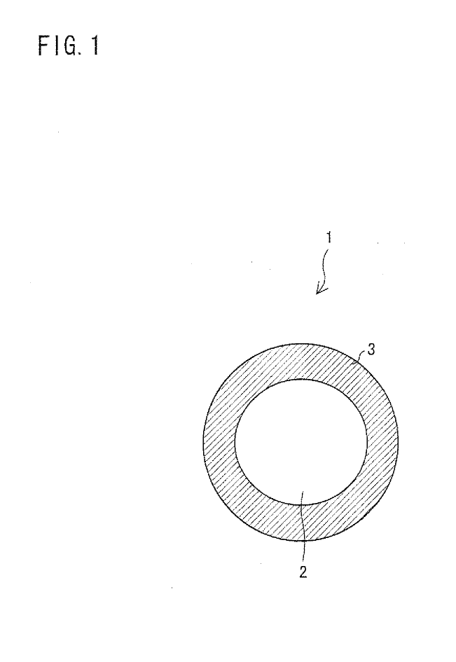

As one embodiment of the present invention, a toner is a toner used in a fixing device where an unfixed toner image formed of the toner on a transfer material is irradiated with laser light having a wavelength in an absorption wavelength range of a color of the toner, so that the toner is fused by light energy to be fixed on the transfer material. As shown in FIG. 1, the toner is a toner 1 having a two-layer structure where a shell layer (coating layer) 3 is formed around the surface of a core particle 2 (such a structure is hereinafter referred to as “core-shell structure”). Hereinafter, such a toner is referred to as “capsule toner 1”. The following will specifically describe (1) toner ingredients and (2) a manufacturing method of the capsule toner 1.

(1) Toner Ingredients

(1-I) Core Particle Resin and Shell Layer Resin

The capsule toner 1 has the two-layer structure where the coating layer is formed around the surface of the core particle, which serves as a toner matrix particle. The core particle resin or the shell layer resin can be, but are not particularly limited to, a binder resin for black toner or color toner. Examples of the binder resin include polyester-based resin, styrene-based resin such as polystyrene and styrene-acrylic ester copolymer resin, acrylic resin such as polymethylmethacrylate (hereinafter referred to as PMMA), polyolefin-based resin such as polyethylene, polyurethane, epoxy resin, and silicone resin.

A refractive index of the core particle is greater than that of the shell layer. Note that the “refractive index” in one embodiment of the present invention refers to “resin refractive index” of the core particle resin or the shell layer resin. The “resin refractive index” is a value that is measured at a wavelength of 589 nm by a conventionally known prism coupling method. Specifically, the “resin refractive index” was measured at a temperature of 20° C. under a light source lamp (D-line (589 nm)) by means of an Abbe refractometer NAR-1T SOLID manufactured by ATAGO Co., Ltd.

Typical resin refractive indices that can be used for the core particle resin or the shell layer resin are as follows: about 1.57 for polyester resin; about 1.56 for styrene-acrylic resin; about 1.49 for polymethylmethacrylate; and about 1.41 for silicone resin.

Alternatively, resins that contains fluorine for adjustment of a resin refractive index and thus have a low refractive index may be used. For example, a fluorine-containing component used to decrease a refractive index of polyester resin can be a diol component including an ethylene oxide adduct of 2,2-bis(4-hydroxyphenyl)hexafluoropropane.

(1-II) Colorant

A colorant for the capsule toner 1 can be a dye or a pigment. Particularly, the pigment is preferable. The pigment is more excellent in light fastness and color appearance than the dye. Therefore, the use of the pigment for the colorant makes it possible to obtain the capsule toner 1 having excellent light fastness and color appearance.

Examples of the colorant include a yellow toner colorant, a magenta toner colorant, a cyan toner colorant, and a black toner colorant.

Examples of the yellow toner colorant includes: organic pigments such as C.I. pigment yellow 1, C.I. pigment yellow 5, C.I. pigment yellow 12, C.I. pigment yellow 15, C.I. pigment yellow 17, C.I. pigment yellow 74, C.I. pigment yellow 93, C.I. pigment yellow 180, and C.I. pigment yellow 185; inorganic pigments such as yellow iron oxide and yellow ocher; nitro dye such as C.I. acid yellow 1; and oil-soluble dye such as C.I. solvent yellow 2, C.I. solvent yellow 6, C.I. solvent yellow 14, C.I. solvent yellow 15, C.I. solvent yellow 19, and C.I. solvent yellow 21, which are all classified according to color index.

Examples of the magenta toner colorant include C.I. pigment red 49, C.I. pigment red 57, C.I. pigment red 81, C.I. pigment red 122, C.I. solvent red 19, C.I. solvent red 49, C.I. Solvent red 52, C.I. basic red 10, and C.I. disperse red 15, which are all classified according to color index.

Examples of the cyan toner colorant include C.I. pigment blue 15, C.I. pigment blue 16, C.I. solvent blue 55, C.I. solvent blue 70, C.I. direct blue 25, and C.I. direct blue 86.

Example of the black toner colorant include carbon black such as channel black, roller black, disk black, gas furnace black, oil furnace black, thermal black, and acetylene black.

Other than these colorants, a purple pigment, a green pigment, and the like may be used. These colorants may be used each alone, and two or more thereof may be used in combination. Further, it is possible to use two or more of the colorants of the same color series and also possible to use one or two or more colorants respectively from different color series.

The colorant is preferably used in form of a master batch. The master batch of the colorant can be manufactured by kneading a molten product of a binder resin and the colorant. For the binder resin, resin is used of the same sort as that of the binder resin of the capsule toner 1 or being highly compatible with the binder resin of the capsule toner 1. A usage of the binder resin and the colorant in the master batch is not particularly limited and is preferably in the range of 30 parts by weight to 100 parts by weight in terms of 100 parts by weight of the binder resin. The master batch is used, for example, with particles granulated to around 2 mm to 3 mm in diameter.

A content of the colorant in the capsule toner 1 is not particularly limited, and is preferably in a range of 4 parts by weight to 20 parts by weight in terms of 100 parts by weight of the binder resin. This makes it possible to obtain the capsule toner 1 that suppresses filler effect caused by addition of the colorant and has high color appearance. When a content of the colorant in the capsule toner exceeds 20 parts by weight, the filler effect caused by the colorant may decrease fixing property of the capsule toner 1.

(1-III) Other Ingredients

The capsule toner 1 may include a release agent, a charge control agent, and other agents, if necessary, as well as the core particle resin, the shell layer resin, and the colorant.

(i) Release Agent A release agent for the capsule toner 1 is added for the purpose of imparting releasability to the capsule toner 1 when the capsule toner 1 is fixed on a recording medium. In this case, a hot offset initiation temperature can be increased, and a hot offset resistance can be thus enhanced, as compared with a case without the release agent. Furthermore, by application of heat in fixing the capsule toner 1, the release agent is fused, a fixing initiation temperature is lowered, and hot offset resistance can be thus improved.

The release agent for use in the present invention is not particularly limited and can be the one commonly used in the relevant field. Examples of the release agent include: petroleum wax such as paraffin wax and derivatives thereof, and microcrystalline wax and derivatives thereof; hydrocarbon-based synthetic wax such as Fischer-Tropsch wax and derivatives thereof, polyolefin wax and derivatives thereof, low-molecular-weight polypropylene wax and derivatives thereof, and polyolefinic polymer wax and derivatives thereof; carnauba wax and derivatives thereof; and ester-based wax. These release agents may be used each alone, or two or more thereof may be used in combination.

A usage of the release agent is not particularly limited and may be appropriately selectable within a wide content range. However, it is preferable that a content of the release agent is in a range of 0.2 parts by weight to 20 parts by weight per 100 parts by weight of the binder resin. When the release agent content is higher than 20 parts by weight per 100 parts by weight of the binder resin, toner filming onto a photoreceptor and toner spent on the carrier may occur. On the other hand, when the release agent content is lower than 0.2 parts by weight per 100 parts by weight of the binder resin, the release agent may not sufficiently exert its own effect.

A melting temperature of the release agent is not particularly limited. However, when the melting temperature thereof is too high, it is impossible to obtain the effect of improving fixing property (releasability) of the capsule toner 1 by virtue of addition of the release agent. On the other hand, when the melting temperature thereof is too low, a preservation ability of the capsule toner 1 and the like are deteriorated. Therefore, a melting temperature of the release agent is preferably in a range of 30° C. to 120° C.

The “melting temperature of the release agent” can be determined as a temperature at a top of an endothermic peak which corresponds to melting shown on a DSC curve, using a differential scanning calorimeter: DSC220 (trade name) manufactured by Seiko Instruments & Electronics Ltd. More specifically, 1 g of a sample release agent is heated from a temperature of 20° C. up to 200° C. at a temperature of which increase rate is 10° C./min, and then an operation of rapidly cooling down the sample from 200° C. to 20° C. is repeated twice, thus obtaining a DSC curve. A temperature obtained at a top of an endothermic peak which corresponds to the melting shown on the DSC curve obtained at the second operation, is determined as the melting temperature of the release agent.

(ii) Charge Control Agent

A charge control agent for the capsule toner 1 is added to impart preferable chargeability to the capsule toner 1. The charge control agent used in the present invention is not particularly limited and can be a conventionally known charge control agent for positive charge control or a conventionally known charge control agent for negative charge control.

Examples of the charge control agent for positive charge control include a nigrosine dye, a basic dye, quaternary ammonium salt, quaternary phosphonium salt, aminopyrine, a pyrimidine compound, a polynuclear polyamino compound, aminosilane, a derivative thereof, a triphenylmethane derivative, guanidine salt, and amidine salt.

Examples of the charge control agent for negative charge control include oil-soluble dyes such as oil black and spiron black; a metal-containing azo compound, an azo complex dye, metal salt naphthenate, salicylic acid, metal complex and metal salt (the metal includes chrome, zinc, and zirconium) of a salicylic acid derivative, a boron compound, a fatty acid soap, long-chain alkylcarboxylic acid salt, and a resin acid soap.

The charge control agents for positive charge control may be used each alone, or two or more thereof may be used in combination. Similarly, the charge control agents for negative charge control may be used each alone, or two or more thereof may be used in combination. A usage of a compatible charge control agent is preferably in a range of 0.5 part by weight to 5 parts by weight per 100 parts by weight of the binder resin, more preferably 0.5 part by weight to 3 parts by weight per 100 parts by weight of the binder resin. When a content of a compatible charge control agent exceeds 5 parts by weight per 100 parts by weight of the binder resin, a carrier is contaminated, which causes scattering of the capsule toner 1. Further, when a content of the compatible charge control agent is less than 0.5 parts by weight, insufficient charging property is imparted to the capsule toner 1.

(2) Manufacturing Method of the Capsule Toner 1

A manufacturing method of the capsule toner 1 according to the present invention is not particularly limited as long as the capsule toner 1 has the core-shell structure, and the manufacturing method can be a known manufacturing method, for example, an aggregation method. The following will specifically describe (I) a manufacturing method of the core particles, and (II) a process of forming the shell layer.

(2-I) Manufacturing Method of the Core Particles

The core particles of the capsule toner 1 according to the present invention serve as toner matrix particles, and can be manufactured by a conventionally known toner manufacturing method, for example, a melt-kneaded pulverization method. The melt-kneaded pulverization method includes (i) a mixing step of dry-mixing a binder resin, a colorant, a release agent, a charge control agent, and other additives, (ii) a melt-kneading step of melt-kneading an admixture obtained in the step (i), (iii) a cooling step of cooling a melt-kneaded product obtained by the step (ii) to solidify the melt-kneaded product, and (iv) a pulverizing step of mechanically pulverizing a solidified product obtained by the step (iii).

For the mixer used for dry-mixing in the mixing step, a known mixer can be used including: for example, a Henschel-type mixing device such as HENSCHELMIXER (trade name) manufactured by Mitsui Mining Co., Ltd., SUPERMIXER (trade name) manufactured by Kawata MFG Co., Ltd., and MECHANOMILL (trade name) manufactured by Okada Seiko Co., Ltd.; ANGMILL (trade name) manufactured by Hosokawa Micron Corporation, HYBRIDIZATION SYSTEM (trade name) manufactured by Nara Machinery Co., Ltd., and COSMOSYSTEM (trade name) manufactured by Kawasaki Heavy Industries, Ltd.

In the melt-kneading step, the admixture prepared in the mixing step is kneaded with stirring into a melt-kneaded product. In melt-kneading the admixture, the admixture is heated to a temperature equal to or higher than a melting temperature of the binder resin. The “temperature equal to or higher than a melting temperature of the binder resin” is generally in the order of 80° C. to 200° C., preferably in the order of 100° C. to 150° C. For the kneading device used in the melt-kneading step, a common device can be used including, for example, a twin-screw extruder, a three roll mill, and a laboplast mill. Specific examples of such a kneading device include single or twin screw extruders such as TEM-100B (trade name) manufactured by Toshiba Machine Co., Ltd., and PCM-65/87 (trade name) manufactured by Ikegai, Ltd., and open roll-type kneading machines such as KNEADEX (trade name) manufactured by Mitsui Mining Co., Ltd.

In the pulverizing step, the solidified product obtained by cooling the melt-kneaded product is pulverized by using a cutting mill, a feather mill, a jet mill, or the like device. These pulverizing devices may be used each alone, or two or more thereof may be used in combination. For example, after the solidified product is pulverized by a cutting mill into a coarsely pulverized product, the coarsely pulverized product is pulverized by a jet mill to obtain core particles having a desired volume average particle size.

Alternatively, in the pulverizing step, the solidified product of the melt-kneaded product is pulverized into coarsely pulverized particles, the obtained coarsely pulverized particles are processed into an aqueous slurry, the aqueous slurry is treated by using a high-pressure homogenizer into fine particles, and the obtained fine particles are then heated, aggregated, and melted in an aqueous medium. In this manner, the core particles can also be produced.

More specifically, through the coarse pulverization, coarse particles having a particle size of about 100 μm to 3 mm is obtained. Coarse pulverization of the solidified product of the melt-kneaded product is carried out by, for example, a jet mill, a hand mill, or the like device. The obtained coarse particles are dispersed in water to prepare an aqueous slurry thereof. In preparing the aqueous slurry, it is preferable that an adequate amount of dispersant, such as sodium dodecylbenzenesulfonate, is dissolved in water so that the coarse particles are dispersed evenly in water.

Next, the obtained aqueous slurry is processed with the high-pressure homogenizer to turn the coarse particles in the aqueous slurry into fine particles, which produces the aqueous slurry containing fine particles having a volume average particle size of about 0.4 μm to 1.0 μm. The aqueous slurry containing the fine particles is heated to aggregate the fine particles which are, then, melt-bonded together to obtain core particles having a desired volume average particle size and an average circularity degree. For example, by appropriately selecting a temperature for heating the aqueous slurry containing the fine particles (hereinafter referred to as heating temperature) and a time for heating the aqueous slurry (hereinafter referred to as heating time), it is possible to obtain the core particles having desired volume average particle size and average circularity degree. The heating temperature is appropriately selected from a range of temperatures equal to or higher than a softening temperature of the binder resin but lower than the heat decomposition temperature of the binder resin. If the heating times are the same, a volume average particle size of the obtained core particles increases with increase in the heating temperature.

Examples of the high-pressure homogenizer, specifically a commercially available high-pressure homogenizer include: a chamber-type high-pressure homogenizer such as MICROFLUIDIZER (trade name: MICROFLUIDICS) manufactured by Microfluidics Corporation, NANOMIZER (trade name) manufactured by Nanomizer Inc., and ALTIMIZER (trade name, manufactured by Sugino Machine Ltd.); HIGH-PRESSURE HOMOGENIZER (trade name) manufactured by Rannie Inc.; HIGH-PRESSURE HOMOGENIZER (trade name) manufactured by Sanmaru Machinery Co., Ltd.; HIGH-PRESSURE HOMOGENIZER (trade name) manufactured by Izumi Food Machinery Co., Ltd.; and NANO3000 (trade name) manufactured by Beryu Co., Ltd.).

The obtained core particles may be subjected to spheroidizing treatment. As the spheroidizing device, a shock type spheroidizing device and a hot air type spheroidizing device can be exemplified. The shock type spheroidizing device can be the one commercially available, such as FACULTY (trade name) manufactured by Hosokawa Micron Corporation and HYBRIDIZATION SYSTEM (trade name) manufactured by Nara Machinery Co., Ltd. The hot air type spheroidizing device can be the one commercially available, such as a surface reforming machine, Meteorainbow (trade name) manufactured by Nippon Pneumatic MFG Co., Ltd.

(2-II) Method of Forming the Shell Layer (Two-Layer Structure Formed by Encapsulation)

Capsule toner particles of the present invention are formed in the following manner. That is, a dispersant of shell particles is added to the dispersant of the core particles obtained by the method mentioned above in Section (2-I) so that the shell particles are aggregated and adhered around the surfaces of the core particles, which in turn coats the surfaces of the core particles with the shell particles.

Fine particles of shell layer resin can be obtained, for example, by emulsion polymerization of monomer components of resin, or by emulsion dispersion of resin by using a homogenizer or the like device into fine particles.

The dispersant for the core particles and the dispersant for the shell particles can be prepared by a conventionally known method. The dispersant having those particles dispersed therein is not particularly limited as long as it is a dispersant where the above particles are dispersed in water or the like dispersing medium. As the dispersant, a dispersant prepared by emulsion polymerization or soap-free emulsion polymerization can be used.

For the capsule toner 1, nb/na is required to be in a range of 0.92 to 0.96 where nb/na is a ratio of a refractive index of the shell layer resin (nb) to a refractive index of the core particle resin (na) (hereinafter also referred to as “refractive index ratio”). It is more preferable that the refractive index ratio (nb/na) falls within the above range, because the obtained capsule toner 1 exhibits high light absorption efficiency and can be heated and molten only by irradiation of laser light, which makes it possible to obtain the capsule toner 1 having an excellent fixing property. When the refractive index ratio (nb/na) exceeds 0.96, release of light from the core particle to the shell layer is hardly prevented, which in turn causes the capsule toner 1 to be insufficiently heated and molten. When the refractive index ratio (nb/na) is less than 0.92, light released from the capsule toner 1 decreases and the amount of light absorbed by the capsule toner 1 of lower layer decreases, which in turn causes the capsule toner 1 to be insufficiently heated and molten. Consequently, it is possible to obtain the capsule toner 1 having high light absorption efficiency and excellent fixing property by appropriately selecting types of resins for the core particle and the shell particle so that the refractive index ratio (nb/na) falls within the above range.

A thickness of the shell layer, made of the shell particle with which the surface of the core particle is coated, is preferably not less than 0.1 μm. When the thickness of the shell layer is less than 0.1 μm, a uniform shell layer cannot be obtained, which decreases light absorption efficiency of the toner.

With the above capsule toner particles, an external additive may be mixed having functions such as enhancing powder fluidity, enhancing frictional chargeability, enhancing heat resistance, improving long-term preservation stability, improving a cleaning property, and controlling a wear characteristic of photoreceptor surface. The external additive to be used can be the one commonly used in the relevant field. The Examples of the external additive include fine inorganic powders, such as fine silica powder, fine titanium oxide powder, and fine alumina powder. For the purpose of hydrophobizing the capsule toner 1, charging control of the capsule toner 1, and other purposes, these fine inorganic powders are preferably treated with an agent such as silicone varnish, various kinds of modified silicone varnish, silicone oil, various kinds of modified silicone oil, a silane coupling agent, a silane coupling agent having a functional group, or other organosilicone compound. The external additive may be used each alone, or two or more thereof may be used in combination.

An amount of the external additive to be added is preferably in the range of 1 part by weight to 10 parts by weight, more preferably 5 parts by weight or less in terms of 100 parts by weight of the toner particles, in view of charge quantity required for the capsule toner 1, influence on photoreceptor wear through addition of the external additive, environmental characteristics of the capsule toner 1, and the like elements. Further, a number average primary particle size of the external additive is preferably in a range of 10 nm to 500 nm. With the use of the external additive having a particle size within the above range, the capsule toner 1 is more likely to exhibit the effect of enhancing flowability.

[3. Developer]

As one embodiment of the present invention, a developer is a one-component developer or a two-component developer each containing the capsule toner 1 of the present invention.

In a case where the capsule toner 1 of the present invention is used as a one-component developer, only the capsule toner 1 is used without a carrier. In a case where the capsule toner 1 is used as the one-component developer, the capsule toner 1 is charged by friction with a development sleeve by means of a blade and a fur brush to attach the capsule toner 1 on the development sleeve, thus conveying the capsule toner 1. In this manner, image forming is completed.

Meanwhile, in a case where the capsule toner 1 of the present invention is used as a two-component developer, the capsule toner 1 is used in combination with a carrier. That is, the two-component developer of the present invention contains the toner of high light absorption efficiency and a carrier. This provides a two-component developer which ensures sufficient fixing property over a long period of time and realizes an image without poor color reproducibility caused by addition of an infrared absorbent.

The carrier to be used can be the one commonly used in the relevant field. Examples of the carrier includes: ferrite containing one material or two or more materials selected from iron, copper, zinc, nickel, cobalt, manganese, and chromium; a resin-coated carrier in which a carrier core particle is surface-coated with a coating material; and a dispersed-in-resin carrier in which the magnetic particles are dispersed in resin.

The coating substance is not particularly limited and can be the one publicly known. Examples of the coating substance include polytetrafluoroethylene, a monochlorotrifluoroethylene polymer, polyvinylidene fluoride, silicone resin, polyester resin, metallic compound of di-tert-butylsalicylic acid, styrene-based resin, acrylic resin, polyacid, polyvinylral, nigrosine, aminoacrylate resin, basic dye, and lake product of basic dye, fine silica powder, and fine alumina powder. The resin used for the dispersed-in-resin carrier is not particularly limited either and includes, for example, styrene-acrylic resin, polyester-based resin, fluorine-based resin, and phenol-based resin. It is preferable that the above substances are selected appropriately according to toner components and may be used each alone, or two or more thereof may be used in combination.

A shape of the carrier is preferably spherical or oblong. Further, a particle size of the carrier is not particularly limited. In consideration of enhancement in image quality, the particle size of the carrier is preferably in a range of 10 μm to 100 μm, preferably 20 μm to 50 μm. Furthermore, resistivity of the carrier is preferably 10⁸ Ωcm or more, and more preferably 10¹²Ω·cm or more. The resistivity of the carrier is a current value obtained in a manner that the carrier is put in a container having a sectional area of 0.50 cm² and having an electrode at its bottom followed by tapping, and a load of 1 kg/cm² is then applied to the particles put in the container, thereafter being subjected to application of voltage which generates an electric field of 1,000 V/cm² between the load and a bottom electrode. When the resistivity of the carrier is small, application of bias voltage to a development sleeve will cause charges to be injected to the carrier, which makes the carrier particles be easily attached to the photoreceptor. Further, in this case, breakdown of the bias voltage occurs more easily.

Magnetization intensity (maximum magnetization) of the carrier is preferably in a range of 10 emu/g to 60 emu/g and more preferably 15 emu/g to 40 emu/g. The magnetization intensity depends on magnetic flux density of the developing roller. Under a condition that the developing roller has normal magnetic flux density, the magnetization intensity less than 10 emu/g will lead to a failure to exercise magnetic binding force, which may cause the carrier to be spattered. When the magnetization intensity exceeds 60 emu/g, it becomes difficult to keep a noncontact state with the image bearing member in a noncontact development where brush of the carrier is too high, and in a contact development, sweeping patterns may appear more frequently in a toner image.

A usage between the capsule toner 1 and the carrier contained in the two-component developer is not particularly limited and may be appropriately selected according to kinds of the capsule toner 1 and carrier. To take the case of the resin-coated carrier (having density of 5 g/cm² to 8 g/cm²) as an example, it is preferable to use the capsule toner 1 in such an amount that the content of the capsule toner 1 in the two-component developer is in a range of 2% by weight to 30% by weight, preferably 2% by weight to 20% by weight based on a total amount of the two-component developer. A coverage of the capsule toner 1 over the carrier in the two-component developer is preferably in a range of 40% to 80%.

[4. Developing Device, Fixing Device, and Image Forming Apparatus]

Provided as one embodiment of the present invention are: a developing device that performs development by using one-component developer composed of a capsule toner 1 of the present invention or a two-component developer containing the capsule toner 1 of the present invention and a carrier, a fixing device including only laser light sources respectively provided for color toners of the present invention, and an image forming apparatus including the developing device and the fixing device.

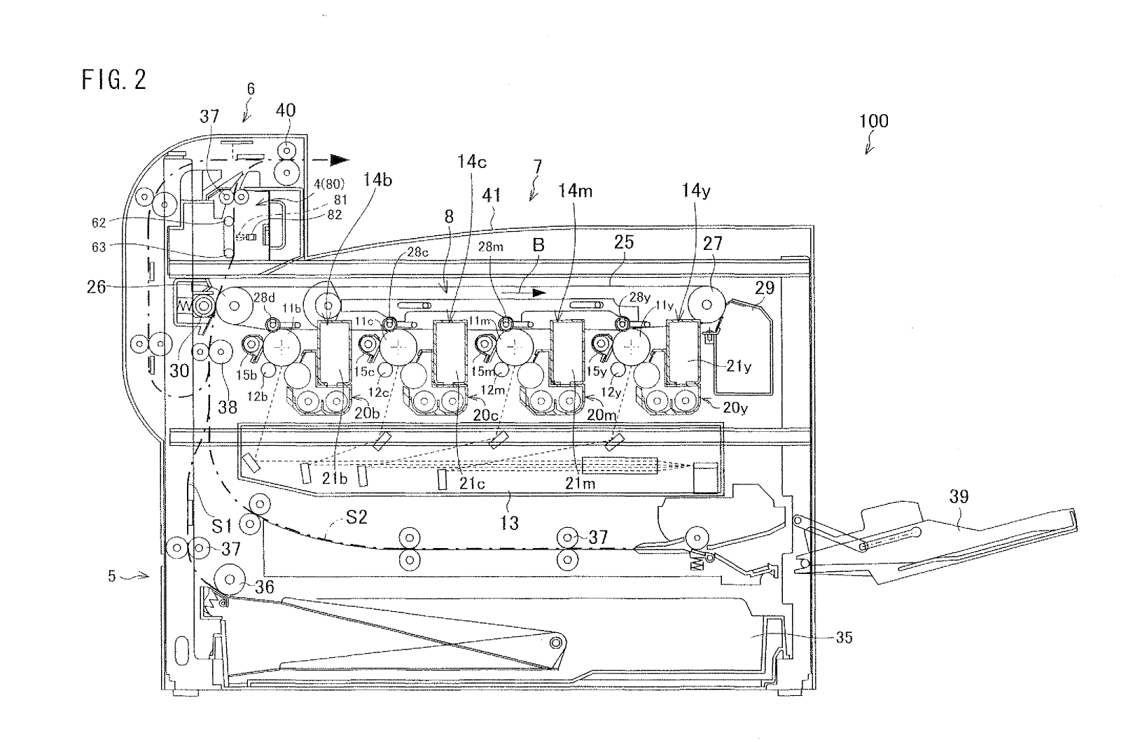

Referring to a cross-sectional view shown in FIG. 2, the configuration of an image forming apparatus 100 according to one embodiment of the present invention will be described below. The image forming apparatus 100 is a multi-function peripheral having a copier function, a printer function and a facsimile function in combination, and forms a full-color or monochromatic image on a recording medium depending upon transmitted image information. That is, the image forming apparatus 100 has three kinds of printing modes, i.e., copier mode (reproduction mode), printer mode and facsimile mode and in which a control section (not shown) selects a printing mode depending upon the reception of an input through an operation section (not shown), or a print job from a personal computer, a portable terminal device, an information storage medium or external equipment using a memory. The image forming apparatus 100 includes a toner image forming section 7, a transfer section 8, a fixing device 4, a recording medium feeding section 5, and a discharge section 6. In accordance with image information of respective colors of black (b), cyan (c), magenta (m), and yellow (y) which are contained in color image information, there are provided respectively four sets of the components constituting the toner image forming section 7 and some parts of the components contained in the transfer section 8. The four sets of respective components provided for the respective colors are distinguished herein by giving alphabets indicating the respective colors to the end of the reference numerals, and in the case where the sets are collectively referred to, only the reference numerals are shown.

The toner image forming section 7 includes a photoreceptor drum 11, a charging section 12, an exposure unit 13, a developing device 14, and a cleaning unit 15. The charging section 12, the developing device 14, and the cleaning unit 15 are arranged in this order along a rotational direction of the photoreceptor drum 11. The charging section 12 is arranged vertically below the developing device 14 and the cleaning unit 15.

The photoreceptor drum 11, which is supported by a drive section (not shown) to be rotatable about an axis thereof, includes a conductive substrate and a photosensitive layer formed around the surface of the conductive substrate, both of which are not shown. The conductive substrate may be formed into various shapes such as a cylindrical shape, a circular columnar shape, and a thin film sheet shape. Among these shapes, the cylindrical shape is preferred. The conductive substrate is formed of a conductive material. The conductive material can be the one commonly used in the relevant field. Examples of the conductive material includes: metals such as aluminum, copper, brass, zinc, nickel, stainless steel, chromium, molybdenum, vanadium, indium, titanium, gold, and platinum; alloys formed of two or more of the metals; a conductive film in which a conductive layer containing one or two or more of aluminum, aluminum alloy, tin oxide, gold, indium oxide, etc. is formed on a film-like substrate such as a synthetic resin film, a metal film, and paper; and a resin composition containing conductive particles and/or conductive polymers. As the film-like substrate used for the conductive film, a synthetic resin film is preferred and a polyester film is particularly preferred. Further, as the method of forming the conductive layer in the conductive film, vapor deposition, coating, etc. are preferred.

The photosensitive layer is formed, for example, by stacking (i) a charge generating layer containing a charge generating substance and (ii) a charge transporting layer containing a charge transporting substance. In this case, an undercoat layer is preferably formed between the conductive substrate and the charge generating layer or the charge transporting layer. when the undercoat layer is provided, the flaws and irregularities present on the surface of the conductive substrate are covered, leading to advantages such that the photosensitive layer has a smooth surface, that chargeability of the photosensitive layer can be prevented from degrading during repetitive use, and that the charging property of the photosensitive layer can be enhanced under a low temperature circumstance and/or a low humidity circumstance. Further, the photosensitive layer may be a laminated photoreceptor having a highly-durable three-layer structure in which a photoreceptor surface-protecting layer is provided on the top layer.

The charge generating layer contains as a main ingredient a charge generating substance that generates electric charges under irradiation of light, and optionally contains known binder resin, plasticizer, sensitizer, etc. The charge generating substance can be the one commonly used in the relevant field. Examples of the charge generating substance includes: perylene pigments such as perylene imide and perylenic acid anhydride; polycyclic quinone pigments such as quinacridone and anthraquinone; phthalocyanine pigments such as metal and non-metal phthalocyanines, and halogenated non-metal phthalocyanines; squalium dyes; azulenium dyes; thiapylirium dyes; and azo pigments having carbazole skeleton, styrylstilbene skeleton, triphenylamine skeleton, dibenzothiophene skeleton, oxadiazole skeleton, fluorenone skeleton, bis-stilbene skeleton, di-styryloxadiazole skeleton, or di-styryl carbazole skeleton.

Among those charge generating substances, non-metal phthalocyanine pigments, oxotitanyl phthalocyanine pigments, bisazo pigments containing fluorene rings and/or fluorenone rings, bisazo pigments containing aromatic amines, and trisazo pigments have high charge generating ability and are suitable for forming a highly-sensitive photosensitive layer. The charge generating substances may be used each alone, or two or more thereof may be used in combination. The content of the charge generating substance is not particularly limited, and preferably in a range of 5 parts by weight to 500 parts by weight, more preferably 10 parts by weight to 200 parts by weight per 100 parts by weight of the binder resin in the charge generating layer. The binder resin for the charge generating layer is not particularly limited and can be the one commonly used in the relevant field. Examples of the binder resin include melamine resin, epoxy resin, silicone resin, polyurethane, acrylic resin, vinyl chloride-vinyl acetate copolymer resin, polycarbonate, phenoxy resin, polyvinyl butyral, polyallylate, polyamide, and polyester. The binder resins may be used each alone or, optionally, two or more thereof may be used in combination.

The charge generating layer can be formed by dissolving or dispersing an appropriate amount of a charge generating substance, a binder resin, and, optionally, a plasticizer, a sensitizer, and/or others respectively in an appropriate organic solvent in which the ingredients described above are dissolvable or dispersible, to thereby prepare a coating solution for charge generating layer, and then applying the coating solution for charge generating layer onto the surface of the conductive substrate, followed by drying the coated surface. A thickness of the thus obtained charge generating layer is not particularly limited, and preferably in the range of 0.05 μm to 5 μm, more preferably in the range of 0.1 μm to 2.5 μm.

The charge transporting layer stacked over the charge generating layer contains as essential ingredients (i) a charge transporting substance capable of receiving and transporting electric charges generated from the charge generating substance and (ii) a binder resin for charge transporting layer. The charge transporting layer may optionally contain known antioxidant, plasticizer, sensitizer, lubricant, etc. The charge transporting substance may be the one commonly used in the relevant field. Examples of the charge transporting substance include: electron donating materials such as poly-N-vinyl carbazole, a derivative thereof, poly-γ-carbazolyl ethyl glutamate, a derivative thereof, a pyrene-formaldehyde condensation product, a derivative thereof, polyvinylpyrene, polyvinyl phenanthrene, an oxazole derivative, an oxadiazole derivative, an imidazole derivative, 9-(p-diethylaminostyryl)anthracene, 1,1-bis(4-dibenzylaminophenyl)propane, styrylanthracene, styrylpyrazoline, a pyrazoline derivative, phenyl hydrazones, a hydrazone derivative, a triphenylamine compound, a tetraphenyldiamine compound, a triphenylmethane compound, a stilbene compound, and an azine compound having 3-methyl-2-benzothiazoline ring; and electron accepting materials such as a fluorenone derivative, a dibenzothiophene derivative, an indenothiophene derivative, a phenanthrenequinone derivative, an indenopyridine derivative, a thioquisantone derivative, a benzo[c]cinnoline derivative, a phenazine oxide derivative, tetracyanoethylene, tetracyanoquinodimethane; bromanil, chloranil, and benzoquinone.

The charge transporting substances may be used each alone, or two or more thereof may be used in combination. The content of the charge transporting substance is not particularly limited, and preferably in a range of 10 parts by weight to 300 parts by weight, more preferably 30 parts by weight to 150 parts by weight, per 100 parts by weight of the binder resin in the charge transporting substance. The binder resin for the charge transporting layer is not particularly limited, and can be the one commonly used in the relevant field and capable of uniformly dispersing the charge transporting substance. Examples of the binder resin includes polycarbonate, polyallylate, polyvinylbutyral, polyamide, polyester, polyketone, epoxy resin, polyurethane, polyvinylketone, polystyrene, polyacrylamide, phenolic resin, phenoxy resin, polysulfone resin, and copolymer resin thereof. Among those materials, it is preferable to use, for example, polycarbonate containing bisphenol Z as a monomer ingredient (hereinafter referred to as “bisphenol Z polycarbonate”), a mixture of bisphenol Z polycarbonate and other polycarbonate, in view of film forming property, wear resistance, and electrical property, and other properties of the obtained charge transporting layer. The binder resins may be used each alone, or two more thereof may be used in combination.

The charge transporting layer preferably contains an antioxidant as well as the charge transporting substance and the binder resin for the charge transporting layer. Also for the antioxidant, materials used commonly in the relevant field can be used including, for example, Vitamin E, hydroquinone, hindered amine, hindered phenol, paraphenylene diamine, arylalkane, derivatives thereof, an organic sulfur compound, and an organic phosphorus compound. The antioxidants may be used each alone, or two or more thereof may be used in combination. The content of the antioxidant is not particularly limited, and is in a range of 0.01% by weight to 10% by weight, preferably in the range of 0.05% by weight to 5% by weight of a total amount of the ingredients constituting the charge transporting layer.

The charge transporting layer can be formed by dissolving or dispersing an appropriate amount of a charge transporting substance, a binder resin, and, optionally, an antioxidant, a plasticizer, a sensitizer, etc. respectively in an appropriate organic solvent which is capable of dissolving or dispersing the ingredients described above, to thereby prepare a coating solution for charge transporting layer, and applying the coating solution for charge transporting layer onto the surface of the charge generating layer, followed by drying the coated surface.

A thickness of the thus obtained charge transporting layer is not particularly limited, and preferably is in a range of 10 μm to 50 μm, more preferably 15 μm to 40 μm. Note that it is possible to form a photosensitive layer where both the charge generating substance and the charge transporting substance are present in one layer. In this case, the kinds and contents of the charge generating substance and the charge transporting substance, the kind of the binder resin, and other additives can be the same as those in the case of forming separately the charge generating layer and the charge transporting layer.

In the embodiment, there is used a photoreceptor drum which has an organic photosensitive layer as described above containing the charge generating substance and the charge transporting substance. It is, however, also possible to use, instead of the above photoreceptor drum, a photoreceptor drum which has an inorganic photosensitive layer containing silicon or the like.

The charging section 12 faces the photoreceptor drum 11 and is disposed away from the surface of the photoreceptor drum 11 when viewed in a longitudinal direction of the photoreceptor drum 11. The charging section 12 charges the surface of the photoreceptor drum 11 so that the surface of the photoreceptor drum 11 has predetermined polarity and potential. As the charging section 12, it is possible to use a charging brush type charging device, a charger type charging device, a pin array type charging device, an ion-generating device, etc. Although the charging section 12 is disposed away from the surface of the photoreceptor drum 11 in the embodiment, the configuration is not limited thereto. For example, a charging roller may be used as the charging section 12, and the charging roller may be disposed in pressure-contact with the photoreceptor drum 11. It is also possible to use a contact-charging type charger such as a charging brush or a magnetic brush.

The exposure unit 13 is disposed in such a position that light beams corresponding to each color information emitted from the exposure unit 13 passes between the charging section 12 and the developing device 14 and reach the surface of the photoreceptor drum 11. In the exposure unit 13, the image information is converted into light beams corresponding to each color information of black, cyan, magenta, and yellow, and the surface of the photoreceptor drum 11 which has been evenly charged by the charging section 12, is exposed to the light beams corresponding to each color information to thereby form electrostatic latent images on the surfaces of the photoreceptor drums 11. The exposure unit 13 can be, for example, a laser scanning unit having a laser-emitting section and a plurality of reflection mirrors. A part from the laser scanning unit, the exposure unit 13 may include an LED (Light Emitting Diode) array and a unit in which a liquid-crystal shutter and a light source are appropriately combined with each other.

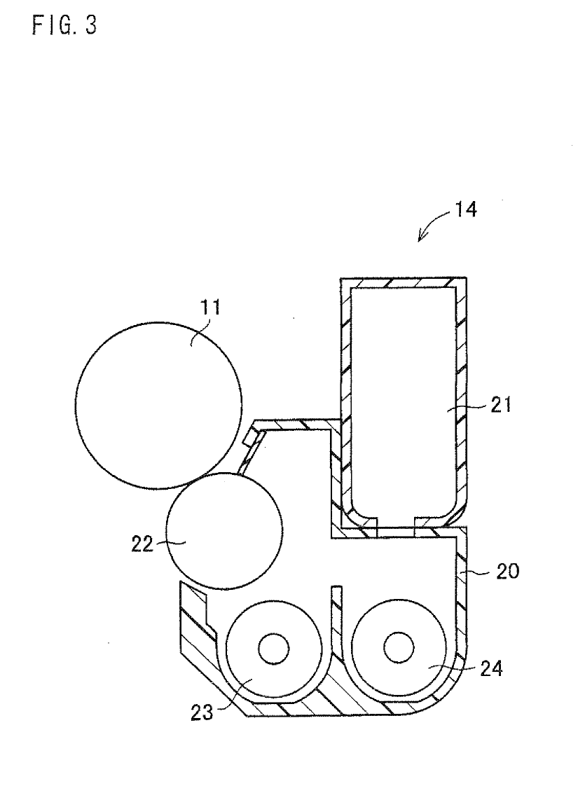

Here, the configuration of the developing device 14 according to one embodiment of the present invention will be described with reference to a cross-sectional view shown in FIG. 3. The developing device 14 performs development by using a one-component developer composed of the capsule toner 1 of the present invention or a two-component developer containing the capsule toner 1 of the present invention and a carrier. That is, the developing device 14 performs development using a developer containing the above-described toner capable of maintaining sufficient fixing property for the long term, which makes it possible to form a toner image on the photoreceptor drum 11.

The developing device 14 includes a developing tank 20 and a toner hopper 21. The developing tank 20 is a container member which is so arranged as to face the surface of the photoreceptor drum 11, feeds the capsule toner 1 to the electrostatic latent image formed on the surface of the photoreceptor drum 11 to develop it to thereby form a toner image which is a visible image. The developing tank 20 contains in its inner space a one-component developer composed of the capsule toner 1 of the present invention or a two-component developer containing the capsule toner 1 of the present invention and a carrier. The developing tank 20 contains roller members such as a development roller 22, a feed roller 23, a stirring roller 24, or screw members, and rotatably supports these members. The developing tank 20 has an opening on a side surface thereof facing the photoreceptor drum 11, and the development roller 22 is provided at a position where it faces the photoreceptor drum 11 through the opening.

The development roller 22 is a roller member that feeds the capsule toner 1 of the present invention to an electrostatic latent image on the surface of the photoreceptor drum 11 at a position where the development roller 22 is in pressure-contact with, or is the closest to, the photoreceptor drum 11. In feeding the capsule toner 1, a potential of a polarity opposite to a charged potential of the capsule toner is applied as a development bias voltage (hereinafter simply referred to as “development bias”) to the surface of the development roller 22. Therefore, the capsule toner 1 on the development roller 22 is smoothly fed to the electrostatic latent image. By changing a value of the development bias, further, the amount of the capsule toner 1 (toner attachment amount) fed to the electrostatic latent image can be controlled.

The feed roller 23 is a roller member rotatably provided facing the development roller 22, and feeds to the periphery of the development roller 22 a one-component developer composed of the capsule toner 1 of the present invention or a two-component developer containing the capsule toner 1 of the present invention and a carrier. The stirring roller 24 is a roller member rotatably provided facing the feed roller 2, and feeds to the periphery of the feed roller 23 the capsule toner 1 of the present invention that is newly fed into the developing tank 20 from the toner hopper 21. The toner hopper 21 is so provided that a toner replenishing port (not shown) provided in a vertically lower part of the toner hopper 21 is communicated with a toner receiving port (not shown) provided in a vertically upper part of the developing tank 20. The toner hopper 21 replenishes the developing tank 20 with the capsule toner 1 according to the consumption of the toner in the developing tank 20. Alternatively, the development tank 20 may be replenished with the capsule toner 1 supplied directly from a toner cartridge of each color without using the toner hopper 21.

Further, the cleaning unit 15 shown in FIG. 2 removes the capsule toner 1 remaining on the surface of the photoreceptor drum 11 after the toner image has been transferred onto the recording medium, and thus cleans the surface of the photoreceptor drum 11. In the cleaning unit 15, a platy member is used such as a cleaning blade. In the image forming apparatus 100 of the present invention, an organic photoreceptor drum is mainly used as the photoreceptor drum 11. A surface of the organic photoreceptor drum contains a resin component as a main ingredient and therefore tends to be degraded by chemical action of ozone which is generated by corona discharging of a charging device. The degraded surface part is, however, worn away by abrasion through the cleaning unit 15 and thus removed reliably, though gradually. Accordingly, the problem of the surface degradation caused by the ozone, etc. is actually solved, and the potential of charge given in the charging operation can be thus maintained stably for a long period of time. Although the cleaning unit 15 is provided in the present embodiment, no limitation is imposed on the configuration and the cleaning unit 15 does not have to be provided.

In the toner image forming section 7, signal light corresponding to image information is emitted from the exposure unit 13 to the surface of the photoreceptor drum 11 which has been evenly charged by the charging section 12, thereby forming an electrostatic latent image; the capsule toner 1 is then supplied from the developing device 14 to the electrostatic latent image, thereby forming a toner image; the toner image is transferred onto an intermediate transfer belt 25; and the capsule toner 1 remaining on the surface of the photoreceptor drum 11 is removed by the cleaning unit 15. A series of the toner image forming operations just described is repeatedly carried out.

The transfer section 8 is disposed, above the photoreceptor drum 11 and includes the intermediate transfer belt 25, a drive roller 26, a driven roller 27, intermediate transfer rollers 28 (b, c, m, y), a transfer belt cleaning unit 29, and a transfer roller 30. The intermediate transfer belt 25 is an endless belt stretched between the drive roller 26 and the driven roller 27, thereby forming a loop-shaped travel path. The intermediate transfer belt 25 rotates in a direction indicated by an arrow B. When the intermediate transfer belt 25 passes through the photoreceptor drum 11 in contact therewith, a transfer bias whose polarity is opposite to the polarity of the charged capsule toner 1 on the surface of the photoreceptor drum 11 is applied from the intermediate transfer roller 28, which is disposed opposite to the photoreceptor drum 11 across the intermediate transfer belt 25, with the result that the toner image formed on the surface of the photoreceptor drum 11 is transferred onto the intermediate transfer belt 25.

In the case of a multicolor image, the toner images of respective colors formed on the respective photoreceptor drums 11 are sequentially transferred and overlaid onto the intermediate transfer belt 25, thus forming a multicolor toner image. The drive roller 26 is provided to be rotatable about the axis thereof by a drive section (not shown). The rotation of the drive roller 26 causes the intermediate transfer belt 25 to rotate in the direction indicated by the arrow B. The driven roller 27 is provided to be rotatable by rotation of the drive roller 26 and imparts constant tension to the intermediate transfer belt 25 so that the intermediate transfer belt 25 does not go slack. The intermediate transfer roller 28 is disposed in pressure-contact with the photoreceptor drum 11 across the intermediate transfer belt 25, and is provided to be rotatable about the axis thereof by a drive section (not shown). The intermediate transfer roller 28 is connected to a power source (not shown) for applying the transfer bias voltage as described above, and has a function of transferring the toner image formed on the surface of the photoreceptor drum 11 onto the intermediate transfer belt 25.

The transfer belt cleaning unit 29 is disposed opposite to the driven roller 27 across the intermediate transfer belt 25 so as to come into contact with the outer circumferential surface of the intermediate transfer belt 25. The residual toner which is attached to the intermediate transfer belt 25 as it comes into contact with the photoreceptor drum 11, may cause contamination on the back side of the recording medium. The transfer belt cleaning unit 29 therefore removes and collects the toner on the surface of the intermediate transfer belt 25. The transfer roller 30 is disposed in pressure-contact with the drive roller 26 across the intermediate transfer belt 25, and is provided to be rotatable about the axis thereof by a drive section (not shown). In a pressure-contact portion (transfer nip portion) between the transfer roller 30 and the drive roller 26, the toner image which has been carried by the intermediate transfer belt 25 and thereby conveyed to the pressure-contact portion is transferred onto the recording medium fed from the recording medium feeding section 5, which will be described later. The recording medium bearing the toner image is fed to the fixing device 4. In the transfer section 8, the toner image is transferred from the photoreceptor drum 11 onto the intermediate transfer belt 25 in the pressure-contact portion between the photoreceptor drum 11 and the intermediate transfer roller 28, and by the intermediate transfer belt 25 rotating in the direction indicated by the arrow B, the transferred toner image is conveyed to the transfer nip portion where the toner image is transferred onto the recording medium.

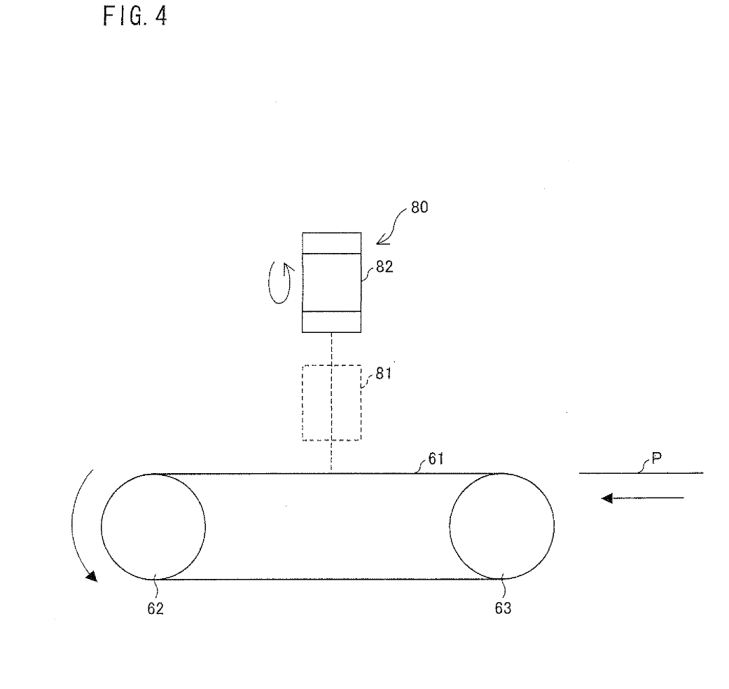

Here, the configuration of the fixing device 4 according to one embodiment of the present invention will be described with reference to a schematic diagram shown in FIG. 4. The fixing device 4 is provided downstream of the transfer section 8 along a conveyance direction of the recording medium, and is constituted by a laser fixing device 80. The laser fixing device 80 is provided with (i) a laser light source that generates laser beams and (ii) a rotary multi-surfaced mirror 82 which reflects laser beams emitted from the laser light source 81 to thereby perform scanning exposure on the endless belt 61. The laser light source 81 is arranged in such a manner that the laser light source 81 is capable of independent outputs of four laser light beams whose oscillation wavelengths are different from each other. Further, the rotary multi-surfaced mirror 82, which comprises a regular hexagonal prism, for example, rotates at a constant speed in a direction indicated by an arrow in FIG. 4. The drive roller 62 is provided to be rotatable about the axis thereof by a drive section (not shown). The rotation of the drive roller 62 causes the endless belt 61 to rotate in the direction indicated by an arrow. The driven roller 63 is provided to be rotatable by rotation of the drive roller 62 and imparts constant tension to the endless belt 61 so that the endless belt 61 does not go slack. Incidentally, a collimator lens, a cylindrical lens, or the like can be provided on an optical path at between the laser light source 81 and the rotary multi-surfaced mirror 82, Meanwhile, an fθ lens, a return mirror, a reflection mirror, or the like mirror can be provided between the rotary multi-surfaced mirror 82 and the endless belt 61.

The laser fixing device 80 irradiates the capsule toner 1 held on a paper sheet P with mutually different light beams, which allows the capsule toner 1 to be fixed onto the paper sheet P in a noncontact manner. Further, the laser fixing device 80 locally irradiates a toner-formed area on the paper sheet P with light.

The laser light source 81 of the laser fixing device 80 is provided with a Y-fixing laser 81Y, an M-fixing laser 81M, a C-fixing laser 81C, a K-fixing laser 81K, of which emission wavelengths are as follows: For example, the Y-fixing laser 81Y emits light at a wavelength corresponding to an absorption peak to the yellow toner in the visible region (e.g. 430 nm). The M-fixing laser 81M emits light at a wavelength corresponding to the absorption peak to the magenta toner in the visible region (e.g. 565 nm). The C-fixing laser 81C emits light at a wavelength corresponding to the absorption peak to the cyan toner in the visible region (e.g. 620 nm). A wavelength of light emitted from the K-fixing laser 81K corresponds to the absorption wavelength of the black toner. Note that the emission wavelength of the K-fixing laser 81K corresponding to the absorption peak to the black toner is not particularly limited and can be determined as appropriate.

A laser intensity is preferably in the range of 1.5 W/cm² to 630 W/cm². If the laser intensity is lower than 1.5 W/cm², a fixing ratio decreases because the capsule toner 1 is insufficiently fused by laser irradiation. On the other hand, if fixing exposure energy is higher than 630 W/cm², the fixing ratio decreases because the scorch of the capsule toner 1 or the paper sheet P occurs due to laser irradiation.

For the duration of time that the paper sheet P passes through, laser light from the Y-fixing laser 81Y is scanned by the rotary multi-surfaced mirror 82 and selectively irradiated to the yellow toner held on the paper sheet P. Thereupon, the laser light irradiated from the Y-fixing laser 81Y is absorbed in the yellow toner on the paper sheet P because the Y-fixing laser 81Y has an emission wavelength corresponding to the absorption wavelength of the yellow toner.

Meanwhile, the laser light from the M-fixing laser 81M is scanned by the rotary multi-surfaced mirror 82 and selectively irradiated to the magenta toner held on the paper sheet P. Thereupon, the laser light irradiated from the M-fixing laser 81M is absorbed in the magenta toner on the paper sheet P because the M-fixing laser 81M has an emission wavelength corresponding to the absorption wavelength of the magenta toner. Thus, the magenta toner is heated and fused by the light absorption.

Meanwhile, the laser light from the C-fixing laser 81C is scanned by the rotary multi-surfaced mirror 82 and selectively irradiated to the cyan toner held on the paper sheet P. Thereupon, the laser light irradiated from the C-fixing laser 81C is absorbed in the cyan toner on the paper sheet P because the C-fixing laser 81C has an emission wavelength corresponding to the absorption wavelength of the cyan toner. Thus, the cyan toner is heated and fused by the light absorption.

The laser light of from the K-fixing laser 81K is scanned by the rotary multi-surfaced mirror 82 and selectively irradiated to the black toner held on the paper sheet P. Thereupon, the laser light irradiated from the K-fixing laser 81K is absorbed in the black toner on the paper sheet P because the K-fixing laser 81K has an emission wavelength corresponding to the absorption wavelength of the black toner. Thus, the black toner is heated up and fused by the light absorption.

As described above, the capsule toner 1 on the paper sheet P is irradiated with the laser light beams corresponding to respective maximum absorption wavelengths of the color toners. As a result of this, the toner image is fixed onto the paper sheet P, whereby an image is formed.

The recording medium feeding section 5 shown in FIG. 2 includes an automatic paper feed tray 35, a pickup roller 36, conveying rollers 37, registration rollers 38, and a manual paper feed tray 39. The automatic paper feed tray 35, which is disposed in a vertically lower part of the image forming apparatus 100, in a box-like member for storing recording mediums. The examples of the recording medium include plain paper, color copy paper, sheets for overhead projector, and postcards. By the pickup roller 36, the recording mediums stored in the automatic paper feed tray 35 are taken out and fed to a paper conveyance path S1 one by one. The conveying rollers 37 are a pair of roller members that are so disposed as to make pressure-contact with each other, and conveys the recording medium toward the registration rollers 38.

The registration rollers 38 are a pair of roller members that are so disposed as to make pressure-contact with each other. By the registration rollers 38, the recording medium fed from the conveying rollers 37 is fed to the transfer nip portion in synchronism with the conveyance of the toner image borne on the intermediate transfer belt 25 to the transfer nip portion. The manual paper feed tray 39 is a device that takes the recording medium in the image forming apparatus 100 by manual operation. The recording medium taken in from the manual paper feed tray 39 passes through a paper conveyance path S2 by means of the conveying rollers 37 and fed to the registration rollers 38. According to the recording medium feeding section 5, the recording mediums fed from the automatic paper feed tray 35 or the manual paper feed tray 39 are each fed one by one to the transfer nip portion in synchronism with the conveyance of the toner image borne on the intermediate transfer belt 25 to the transfer nip portion.

The discharge section 6 includes the conveying rollers 37, discharge rollers 40, and a catch tray 41. The conveying rollers 37, which are provided downstream of the fixing nip portion along a direction in which a paper sheet is conveyed, conveys toward the discharge rollers 40 the recording medium having the image fixed thereon by the fixing device 4. By the discharge rollers 40, the recording medium having the image fixed thereon is discharged into the catch tray 41, which is disposed on a vertically upper surface of the image forming apparatus 100. The catch tray 41 stores the recording medium having the images fixed thereon.

The image forming apparatus 100 includes a control unit (not shown). For example, the control means is disposed in the upper part of the interior space of the image forming apparatus 100, and includes a storage section, a computing section, and a control section. The storage section of the control means receives input of, for example, various setting values provided via an operation panel (not shown) disposed on the top surface of the image forming apparatus 100, the results of detection produced by sensors (not shown) or the like devices arranged at predetermined locations within the image forming apparatus 100, and image information provided from an external apparatus. Moreover, programs for operating various functional elements are written to the storage section. The “various functional elements” refer to, for example, recording medium identifying means for identifying recording media, attachment amount control means for controlling the amount of the capsule toner 1 to be attached, and fixing condition control means for controlling fixing conditions of the capsule toner 1. As the storage section, those used commonly in the relevant field can be used. The examples thereof include a read-only memory (ROM), a random-access memory (RAM), and a hard disk drive (HDD).

As the external apparatus, electrical/electronic apparatuses that allow formation or acquisition of image information and are electrically connectable to the image forming apparatus 100 can be used. The examples thereof include a computer, a digital camera, a television set, a video recorder, a DVD (Digital Versatile Disc) recorder, a HDDVD (High-Definition Digital Versatile Disc), a Blu-ray Disc recorder, a facsimile machine, and a portable terminal apparatus. The computing section retrieves various data written to the storage section (an image formation command, the result of detection, image information, etc.) and the programs for the various functional elements to carry out judgment operations. In response to the result of judgment produced by the computing section, the control section issues control signals to relevant devices, thus performing control on operations. The control section and the computing section include a processing circuit realized by a microcomputer, a microprocessor, or the like device having a central processing unit (CPU). The control means includes a main power source as well as the above-described processing circuit. The power source supplies power to not only the control means but also devices provided inside the image forming apparatus 100.

A toner of the present invention is preferably a cyan toner, a magenta toner, or a yellow toner.

A black toner does not necessarily arranged as in the present invention because the black toner has an excellent efficiency of light absorption. The toner of the present invention is a color toner, which more prominently expresses the advantageous effect of obtaining an image without poor color reproducibility caused by an infrared absorbent.

A developing device of the present invention preferably performs development using a two-component developer of the present invention.

According to the above arrangement, the developing device performs development using the two-component developer of the present invention. Therefore, it is possible to provide a developing device which ensures sufficient fixing property over a long period of time and realizes an image without poor color reproducibility caused by addition of an infrared absorbent.

An image forming apparatus of the present invention preferably includes (i) a developing device that performs development using the two component developer of the present invention and (ii) a fixing device of the present invention. According to the above arrangement, the image forming apparatus includes the developing device and the fixing device. Therefore, it is possible to provide an image forming apparatus which ensures sufficient fixing property over a long period of time and realizes an image without poor color reproducibility caused by addition of an infrared absorbent.

### EXAMPLES

Hereinafter, the present invention will be described in detail by way of Examples. However, the present invention is not limited thereto.

<Resin Refractive Index>

As to a core particle resin and a shell particle resin of a capsule toner, respective refractive indices can be measured at a wavelength of 633 nm by a conventionally known prism coupling method as described above in Section

[1. Toner]

<Volume Average Particle Size of Toner>

To 50 ml of electrolyte: ISOTON-II (trade name) manufactured by Beckman Coulter, Inc. were added 20 mg of a sample and 1 ml of alkyl ether sulfuric ester sodium (a dispersant), which were then subjected to a three-minute dispersion treatment of an ultrasonic distributor: UH-50 (trade name) manufactured by SMT Co., Ltd. at ultrasonic frequency of 20 kHz, thereby preparing a measurement sample. Particles sizes of the measurement sample were measured by a particle size distribution-measuring device: MULTISIZER III (trade name) manufactured by Beckman Coulter, Inc. under the conditions that an aperture diameter was 100 μm and the number of particles for measurement was 50,000 counts. A volume average particle size of the toner was determined from the particle size distribution of the sample particles.

<Glass Transition Temperature (Tg) of Binder Resin>

Using a differential scanning calorimeter DSC220 (trade name) manufactured by Seiko Electronics Inc., 1 g of a sample was heated at a temperature of which increase rate was 10° C./min based on Japanese Industrial Standards (JIS) K7121-1987, thus obtaining a DSC curve. A straight line was drawn toward a low temperature side extendedly from a base line on the high-temperature side of an endothermic peak corresponding to glass transition of the DSC curve which had been obtained as above. A tangent line was also drawn at a point where a gradient thereof was maximum against a curve extending from a rising part to a top of the peak. A temperature at an intersection of the straight line and the tangent line was determined as the glass transition temperature (Tg).

<Softening Temperature (Tm) of Binder Resin>

Using a device for evaluating flow characteristics: FLOWTESTER CFT-100C (trade name) manufactured by Shimadzu Corporation, 1 g of a sample was heated at a temperature of which increase rate was 6° C./min, under load of 10 kgf/cm² (9.8×10⁵ Pa) so as to be pushed out of a die, and a temperature of the sample at the time when a half of the sample had flowed out of the die was determined as the softening temperature (Tm). The die used above was 1 mm in a nozzle aperture and 1 mm in length.

### 1. Manufacture of Two-Component Developer

### Example 1

### (1) Manufacture of Core Resin

87.5 parts by weight of styrene-acrylic resin (having refractive index of 1.56, glass transition temperature Tg of 55° C., and softening temperature Tm of 110° C.) which serves as a binder resin, 8 parts by weight of colorant (trade name: KET BLUE 111 manufactured by DIC Corporation), 3 parts by weight of polyester-based wax (having melting temperature of 85° C.) which serves as a release agent, and 1.5 parts by weight of charge control agent (BONTRON E84 (trade name) manufactured by Orient Chemical Industries, Ltd.) were mixed by a mixer (HENSCHELMIXER (trade name) manufactured by Mitsui Mining Co., Ltd.). Using a twin screw extruder (PCM-30 (trade name) manufactured by Ikegai, Ltd.), an obtained admixture was then melt-kneaded at a cylinder temperature of 145° C. and a barrel rotational speed of 300 rpm to prepare a melt-kneaded product. The melt-kneaded product was cooled down to room temperature and then coarsely pulverized by a cutting mill (VM-16 (trade name) manufactured by Seishin Enterprise Co., Ltd.) to prepare coarse particles having a particle size of not larger than 100 μm.

A total of 800 g of the following ingredients for slurry of coarse particles were mixed together: 40 g of the thus obtained coarse particles; 13.3 g of xanthanegum; 4 g of sodium dodecylbenzenesulfonate (LUNOX S-100 (trade name), anionic dispersant, manufactured by Toho Chemical Industry Co., Ltd.); 0.67 g of sulfosuccinic acid surfactant (AEROLE CT-1p (trade name), chief component: sodium dioctylsulfosuccinate, manufactured by Toho Chemical Industry Co., Ltd.); and 742.03 g of water. The obtained admixture was put into a mixer (NEW GENERATION MIXER NGM-1.5TL (trade name) manufactured by Beryu, Co., Ltd.), stirred at 2000 rpm for 5 minutes, and then deaerated to obtain a slurry of coarse particles.

800 g of the thus obtained slurry of coarse particles was put into a tank of a high-pressure homogenizer (NANO3000 (trade name) manufactured by Beryu Co., Ltd.) and then circulated in the high-pressure homogenizer maintaining a temperature of 185° C. under a pressure of 210 MPa for 30 minutes to obtain a slurry of resin particles.

600 g of the above-mentioned slurry of resin particles and 30 g of an aqueous solution containing 20% of stearyltrimethylammonium chloride (KHOTAMIN 86W (trade name), manufactured by Kao Corporation) were put into a granulating device (NEW GENERATION MIXER NGM-1.5TL (trade name) manufactured by Beryu, Co., Ltd.), stirred at 75° C. and 2000 rpm for 30 minutes, after which a temperature was increased to 85° C. and the admixture was stirred for another 2 hours. After a temperature increase, 300 g of water was added to the admixture to aggregate unaggregated fine particles, and the admixture was cooled down to room temperature to obtain a slurry of core particles. A volume average particle size of the thus obtained slurry of core particles was 7 μm.

A coiled pipe of a heater used in the present Examples had a coil inner diameter of 4.0 mm, a coil radius (coil curvature radius) of 40 mm, and a coil of 50 turns. A nozzle for pulverization used was the one having a nozzle length of 0.4 mm and a single longitudinal flow path having a diameter of 0.09 mm. As a depressurizing module, a pressure-resistant nozzle was used. The pressure-resistant nozzle had a nozzle length of 150 mm, a nozzle inlet diameter of 2.5 mm and a nozzle outlet diameter of 0.3 mm.

### (2) Shell Layer Resin Particles

As shell layer resin particles, PMMA fine particles (having a refractive index of 1.49) (MP-1451 (trade name) manufactured by Soken Chemical & Engineering Co., Ltd.) having a volume average particle size of 0.15 μm were used.

### (3) Manufacture of Capsule Toner Particles

450 g of the obtained slurry of core particles and 45 g of the shell layer resin particles were placed into a 500-ml rotor/screen-type high-speed emulsifier (CLEARMIX manufactured by M Technique Co., Ltd.) having a clearance of 0.2 mm, and the admixture was treated for 10 minutes under the conditions where a liquid temperature was 80° C. and a rotor's rotational speed was 18 m/sec. Then, the obtained product was filtered to take out particles, after which the particles were washed with water 5 times and were then dried with hot air heated at 75° C. to thereby obtain capsule toner particles.

### (4) Manufacture of Capsule Toner

With 100 parts by weight of the obtained capsule toner particles, 3.8 parts by weight in total of the external additives were mixed by the Henschel mixer: FMMIXER (trade name) manufactured by Mitsui Mining Co., Ltd. The external additives consisted of 2.2 parts by weight of hydrophobic silica: R-974 (trade name) manufactured by Nippon Aerosil Co., Ltd. and 1.6 parts by weight of hydrophobic titanium: T-805 (trade name) manufactured by Nippon Aerosil Co., Ltd. A capsule toner was thus prepared.

### (5) Manufacture of Two-Component Developer

A ferrite core carrier having a volume average particle size of 45 μm was used as a carrier. A toner and the carrier were mixed for 20 minutes by means of a V-type mixer; V-5 (trade name) manufactured by Tokuju Corporation so that the concentration of the toner in the two-component developer was 7%, thus preparing the two-component developer of Example 1.

### Example 2

A two-component developer of Example 2 was obtained in the same manner as in Example 1, except that PMMA (having a refractive index of 1.49) was used as the core particle resin, and silicone resin (having a refractive index of 1.41) was used as the shell layer resin.

### Example 3

A two-component developer of Example 3 was obtained in the same manner as in Example 1, except that polyester resin (having a refractive index of 1.57) was used as the core particle resin, and PMMA fine particles (having a refractive index of 1.49) were used as the shell layer resin.

### Example 4

A two-component developer of Example 4 was obtained in the same manner as in Example 1, except that fluorine-containing polyester resin (having a refractive index of 1.54) was used as the core particle resin, and silicone resin (having a refractive index of 1.41) was used as the shell layer resin.

### Comparative Example 1

A two-component developer of Comparative Example 1 was obtained in the same manner as in Example 1, except that fluorine-containing polyester resin (having a refractive index of 1.54) was used as the core particle resin, and PMMA fine particles (having a refractive index of 1.49) were used as the shell layer resin.

### Comparative Example 2

A two-component developer of Comparative Example 2 was obtained in the same manner as in Example 1, except that fluorine-containing polyester resin (having a refractive index of 1.55) was used as the core particle resin, and silicone resin (having a refractive index of 1.41) was used as the shell layer resin.

### Comparative Example 3

A two-component developer of Comparative Example 3 was obtained in the same manner as in Example 1, except that polyester resin (having a refractive index of 1.57) was used as the core particle resin, and styrene-acrylic resin (having a refractive index of 1.56) was used as the shell layer resin.

The refractive indices and refractive index ratios (nb/na) of the core particle resins and the shell layer resins used in Examples and Comparative Examples are shown in Table 1

TABLE 1

| | core particles | | shell layer | | refractive |
|---|---|---|---|---|---|
| | | refractive | | refractive | index |
| | resins | index (na) | resins | index (nb) | ratio (nb/na) |
| Example 1 | styrene-acrylic | 1.56 | PMMA | 1.49 | 0.96 |
| | resin | | | | |
| Example 2 | PMMA | 1.49 | silicone | 1.41 | 0.95 |
| | | | resin | | |
| Example 3 | polyester resin | 1.57 | PMMA | 1.49 | 0.95 |
| Example 4 | fluorine-containing | 1.54 | silicone | 1.41 | 0.92 |
| | polyester resin | | resin | | |
| Comparative | fluorine-containing | 1.54 | PMMA | 1.49 | 0.97 |
| Example 1 | polyester resin | | | | |
| Comparative | fluorine-containing | 1.55 | silicone | 1.41 | 0.91 |
| Example 2 | polyester resin | | resin | | |
| Comparative | polyester resin | 1.57 | styrene- | 1.56 | 0.99 |
| Example 3 | | | acrylic resin | | |

### 2. Evaluation of Fixing Property

A commercially-available copier: MX-2700 (trade name) manufactured by Sharp Corporation with its fixing device modified as shown in FIG. 4 (Y-fixing laser: 430 nm, M-fixing laser: 565 nm, C-fixing laser: 620 nm, K-fixing laser: 780 nm, output: 30 W) was filled with each of the two-component developers obtained in Examples and Comparative Examples. Using the above copier, a solid image was fixed so as to have a toner attachment amount of 1.2 mg/cm² (equivalent to two capsule toner layers). Consequently, an image for evaluation was created.

In a gakushinshiki fastness test, a sand eraser (LION RUBBER ERASER GYAZASUNA (trade name) manufactured by LION office Products Corp.) with a load of 1 kg was moved over the surface of the created image for evaluation backward and forward three times at a speed of 14 mm/s. Optical reflective densities (image densities) of the image before and after the eraser treatment were measured by a reflective densitometer (RD-914 (trade name) manufactured by Macbeth Process Measurements Co.). From the density values, a fixing ratio was calculated by the following equation (1):

Fixing ratio (%)=[(image density after eraser treatment)/(image density before eraser treatment)]×100 (1)

If the fixing ratio obtained by the equation (1) was not less than 70%, the capsule toners were regarded as having sufficient fixing property.

Table 2 shows fixing ratios of the two-component developers of Examples 1-4 and Comparative Examples 1-3.

TABLE 2

fixing property

| | fixing ratio (%) | ratings |
|---|---|---|
| Example 1 | 75 | ∘ |
| Example 2 | 85 | ∘ |
| Example 3 | 83 | ∘ |
| Example 4 | 72 | ∘ |
| Comparative Example 1 | 65 | x |
| Comparative Example 2 | 68 | x |
| Comparative Example 3 | 55 | x |

In Table 2, O represents that a fixing ratio (%) is not less than 70%, and x represents that a fixing ratio (%) is less than 70%.

The above fixing property evaluation proved that a capsule toner of the present invention ensures sufficient fixing property only by the laser fixing system.

The present invention is not limited to the aforementioned embodiments and is susceptible of various changes within the scope of the accompanying claims. Also, an embodiment obtained by suitable combinations of technical means disclosed in the different embodiments are also included within the technical scope of the present invention.

### INDUSTRIAL APPLICABILITY

A capsule toner of the present invention is applicable to a one-component developer composed of the capsule toner or a two-component developer containing the capsule toner and a carrier. Further, the capsule toner of the present invention is applicable to various kinds of image forming apparatuses each including: a developing device that performs development using the one-component developer or the two-component developer; and a fixing device.

### REFERENCE SIGNS LIST

1 capsule toner
2 core particle
3 shell layer (coating layer)
4 fixing device
14 developing device
80 laser fixing device
81 laser light source
100 image forming apparatus

1. A toner used in a fixing device where an unfixed toner image formed of the toner on a transfer material is irradiated with laser light having a wavelength in an absorption wavelength range of a color of the toner, so that the toner is fused by light energy to be fixed on the transfer material, wherein:
the toner has a two-layer structure where a coating layer is formed around a surface of a core particle serving as a toner matrix particle; and
nb/na is in a range of 0.92 to 0.96 where nb/na is a ratio of a refractive index of a resin making up the coating layer (nb) to a refractive index of a resin making up the core particle (na).

2. The toner according to claim 1, wherein
the toner is a cyan toner, a magenta toner, or a yellow toner.

3. A two-component developer comprising:
a toner used in a fixing device where an unfixed toner image formed of the toner on a transfer material is irradiated with laser light having a wavelength in an absorption wavelength range of a color of the toner, so that the toner is fused by light energy to be fixed on the transfer material, wherein the toner has a two-layer structure where a coating layer is formed around a surface of a core particle serving as a toner matrix particle, and nb/na is in a range of 0.92 to 0.96 where nb/na is a ratio of a refractive index of a resin making up the coating layer (nb) to a refractive index of a resin making up the core particle (na); and
a carrier.

4. A developing device performing development using a developer that contains a toner used in a fixing device where an unfixed toner image formed of the toner on a transfer material is irradiated with laser light having a wavelength in an absorption wavelength range of a color of the toner, so that the toner is fused by light energy to be fixed on the transfer material, wherein the toner has a two-layer structure where a coating layer is formed around a surface of a core particle serving as a toner matrix particle, and nb/na is in a range of 0.92 to 0.96 where nb/na is a ratio of a refractive index of a resin making up the coating layer (nb) to a refractive index of a resin making up the core particle (na).

5. The developing device according to claim 4, wherein
the developer is of two-component further containing a carrier.

6. A fixing device where an unfixed toner image formed of a toner on a transfer material is irradiated with light from a light source, so that the toner is fused by light energy to be fixed on the transfer material, wherein:
the light source comprises only laser light sources provided for respective colors of toners to be used;
each of the laser light sources emits laser light having a wavelength in an absorption wavelength range of any particular color of the colors; and
the toner has a two-layer structure where a coating layer is formed around a surface of a core particle serving as a toner matrix particle, and nb/na is in a range of 0.92 to 0.96 where nb/na is a ratio of a refractive index of a resin making up the coating layer (nb) to a refractive index of a resin making up the core particle (na).

7. An image forming apparatus comprising:
(i) a developing device performing development using a developer that contains a toner wherein: the toner has a two-layer structure where a coating layer is formed around a surface of a core particle serving as a toner matrix particle; and nb/na is in a range of 0.92 to 0.96 where nb/na is a ratio of a refractive index of a resin making up the coating layer (nb) to a refractive index of a resin making up the core particle (na); and
(ii) a fixing device where an unfixed toner image formed of the toner on a transfer material is irradiated with light from a light source, so that the toner is fused by light energy to be fixed on the transfer material, wherein the light source comprises only laser light sources provided for respective colors of toners to be used, and each of the laser light sources emits laser light having a wavelength in an absorption wavelength range of any particular color of the colors.

8. The image forming apparatus according to claim 7, wherein
the developer is of two-component further containing a carrier.
